(19) United States
(12) Patent Application Publication
(10) Pub. No.: US 2012/0255876 A1
(43) Pub. Date: Oct. 11, 2012

(54) METHOD AND DEVICE FOR DETERMINING THE CONCENTRATION OF OXIDIZING AGENT(S) IN AN AQUEOUS SOLUTION

(76) Inventors: Robert HERMANN, Oberaich (AT); Michael SCHELCH, Oberaich (AT); Wolfgang STABER, Bruck an der Mur (AT); Wolfgang WESNER, Wien (AT)

(21) Appl. No.: 13/440,593

(22) Filed: Apr. 5, 2012

(30) Foreign Application Priority Data
Apr. 6, 2011 (AT) A 487/2011

(51) Int. Cl. G01N 27/26

(52) U.S. Cl. 205/789

(57) ABSTRACT

In a method and a device for determining the concentration of one or more oxidizing agents in an aqueous solution flowing in a main stream, a partial flow of the aqueous solution is diverted to a bypass, wherein the difference between the potential of the aqueous solution before and after at least partial and/or selective breakdown of any oxidizing agents is measured. The bypass is for diverting and returning the partial flow of the aqueous solution, and has at least one elimination unit through which the aqueous solution flows for at least partial and/or selective breakdown of the oxidizing agent(s), and two measuring electrodes for determining the difference between the potentials of the aqueous solution before and after it passes through the elimination unit.

The invention relates to a method and a device for determining the concentration of one or more oxidizing agents in an aqueous solution flowing in a main stream.

It is usual to use oxidizing agents such as free chlorine, hypochlorite, ozone, hydrogen peroxide and the like to disinfect water, for water conservation and water treatment. Both drinking water and bathing water, such as is used in swimming pools, swimming ponds, jacuzzis, bathtubs and the like, whether for public or private use, are treated with oxidizing agents. Oxidizing agents are used for treating process water in many industrial applications as well. Thus, for example, oxidizing agents are added to rinsing water in the food industry and service water from rainwater collection systems or the discharge from sewage treatment systems to eliminate bacteria and ensure that the chemical oxygen demand (COD) is lowered. Besides the classic oxidizing agents listed in the preceding, in recent times increasing use has been made of peroxides, percarbonates and persulphates. Because of its good penetration in biological materials, chlorine dioxide is used in particular to combat biofilms in tanks and pipelines. Additionally, processes in which oxidizing agents or mixtures of oxidizing agents are produced directly in situ by anodic oxidation of defined solutions or anodic oxidation of the very medium that is to be treated are becoming increasingly widespread. This medium also functions as the anolyte. Whereas in the beginning titanium-based mixed oxide electrodes predominated, and preferably produced chlorine, most electrodes nowadays are diamond doped with boron, which yield various mixtures of oxidizing agents depending on the electrolyte, and the combination of these oxidizing agents lead to more complete oxidizing reactions and better disinfection performances even though the individual active agents are in lower concentrations.

Regardless of whether the oxidizing agents are added in metered quantities or produced in place, it is important to adjust the concentration of oxidizing agents according to their application. Since oxidizing agents are consumed according to the chemical oxygen demand of the respective aqueous solution, and this consumption is dependent on the degree of contamination, which is usually very difficult to predict, a reliable, measurement and control unit that may be automated to adjust the addition of oxidizing agent is of high interest. Various methods are known from the related art for determining the current concentration of oxidizing agents in aqueous solutions. Such methods include photometric methods, particularly DPD tests 1-3 for measuring free and bound chlorine. Photometric methods can only be automated with the aid of relatively expensive equipment, they are associated with constant consumption of chemicals, and they only capture certain oxidizing agents. In addition, the redox potential provides qualitative information about the presence of certain oxidizing agents. For example, a redox potential greater than 700 mV is used an indicator for sufficient chlorination for swimming pools. Since different oxidizing agents result in different redox potentials, quantitative conclusions regarding the concentrations of the respective oxidizing agents cannot be derived from these measurements. Chlorine, chlorine dioxide and ozone are also measurable directly on the basis of absorption in the infrared range. However, turbidity of any kind will distort this measurement. Other oxidizing agents cannot be captured using this type of measurement.

In addition, amperometric methods are known with which it is possible to quantify one or more oxidizing agent depending on the electrode material used, selective membranes if any, and the voltage applied. The measuring electrodes must be calibrated and the membranes replaced regularly. If no membranes are used, the current flow causes the precipitation of quicklime or metals, iron and manganese for example, at the measuring electrodes, so these need to be cleaned regularly.

The object of the invention is to provide a simple, reliable measuring method that is easy to implement and a simple, sturdy device for determining the concentration of oxidizing agents or mixtures of oxidizing agents in aqueous solutions.

The stated object is solved according to the invention by diverting a partial flow of the aqueous solution from the main flow to a bypass, wherein the difference between the potential of the aqueous solution before and after at least partial and/or selective breakdown of any oxidizing agents present is measured in the bypass.

The invention thus provides a reliable, easily implementable method for determining the concentration of oxidizing agent in aqueous solutions.

Only two measuring electrodes are required in order to determine the potential difference. Measuring electrodes of the first kind are most suitable, particularly stainless steel electrodes, titanium mixed electrodes, graphite electrodes, carbon electrodes or boron-doped diamond electrodes. The two measuring electrodes may be identical or different.

The oxidizing agent or agents may be broken down at least partially and/or selectively in particularly simple and effective manner as they flow through an activated charcoal bed. Additionally or alternatively thereto, the aqueous solution may flow through at least one catalyst, preferably made from platinum, palladium or nickel, wherein the catalyst may also be a selective platinum- or palladium-based catalyst that has been poisoned with a catalyst poison, such as metals or metal ions.

Depending on the oxidizing agent that is present, it may also be advantageous to place the activated charcoal bed or catalyst on a cathodic potential, so that an oxidizing agent that is reducible with a given potential may be broken down selectively by applying the appropriate reduction potential.

Also alternatively or additionally thereto, an oxidizing agent may be broken down at least partially or selectively within the terms of the inventive method by a reducing agent, such as H₂, which is produced at another electrode. Suitable reducing agents may also be generated at other electrodes by electrochemical dissolution within the terms of the invention.

It is also possible within the terms of the invention to eliminate the oxidizing agent or agents at least partially or selectively by adding a metered quantity of a reducing agent, such as H₂ for example.

Other additional or alternative means that are conceivable for breaking down the oxidizing agent or agents include UV irradiation, thermal treatment or ultrasound.

The invention further relates to a device for determining the concentration of oxidizing agents in an aqueous solution flowing in a main stream. This device comprises at least one elimination unit located in the bypass of the partial stream of aqueous solution for the at least partial and/or selective breakdown of the oxidizing agent or agents, and two measuring electrodes for determining the difference between the potentials of the aqueous solution in the partial stream before and after it passes through the elimination unit. The device according to the invention is thus of simple, suitable construction and reliable operation.

The device is provided with corresponding measuring electronics or coupled to such.

In the simplest case, the elimination unit is a pipe, a tube or similar that contains an activated charcoal bed and/or at least one catalyst. This catalyst may particularly be a catalyst of platinum, palladium or nickel or platinum- or palladium-based catalyst that is poisoned with a catalyst poison.

Additionally or alternatively thereto, the device has at least one dosing device for the metered introduction of reducing agent into the elimination unit.

The device may have a further electrode for applying a cathodic potential to the active charcoal bed. Within the terms of the invention, the device may also have an electrode for generating hydrogen positioned upstream of the elimination unit. In one embodiment of the invention, the device has at least one further electrode, also positioned upstream of the elimination unit, which electrode releases a reducing agent by electrochemical dissolution. The anodes paired with the additional electrodes are positioned downstream from the second measuring electrode.

Various measures may be implemented to feed the partial stream into the device and maintain a constant flowrate. The provision of an electric pump in the device is simple and reliable. However, hydraulic components such as valves, chokes, butterfly valves, diaphragms and the like are also suitable.

One very simple and reliable option for ensuring a constant flowrate is to use a flow controller, which is installed upstream from the elimination unit.

Measurement signals from the measuring electronics are used in accordance with the invention to control an oxidizing agent metered supply device or a device for in situ production of oxidizing agent. The device is also expediently designed as a replaceable unit that comprises at least the measuring electrodes and the elimination unit. The measuring electronics may advantageously be at least partially integrated in this replaceable unit.

Further features, advantages and details of the invention will now be described in greater detail with reference to the diagrammatic drawing, which represents embodiments. In the drawing:

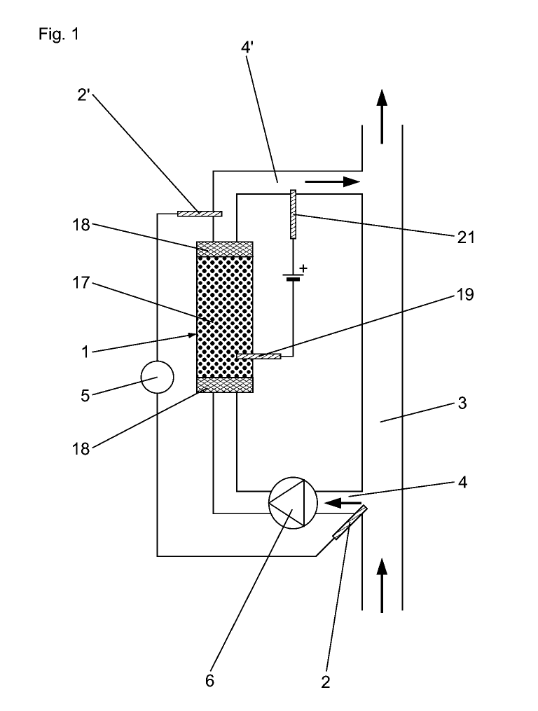

FIG. 1 is a view of a design variant of a device according to the invention,

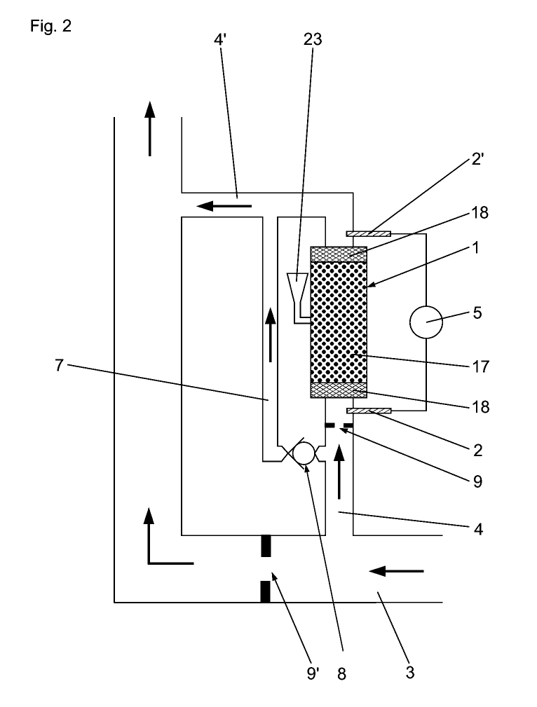

FIG. 2 is a second design variant of a device according to the invention,

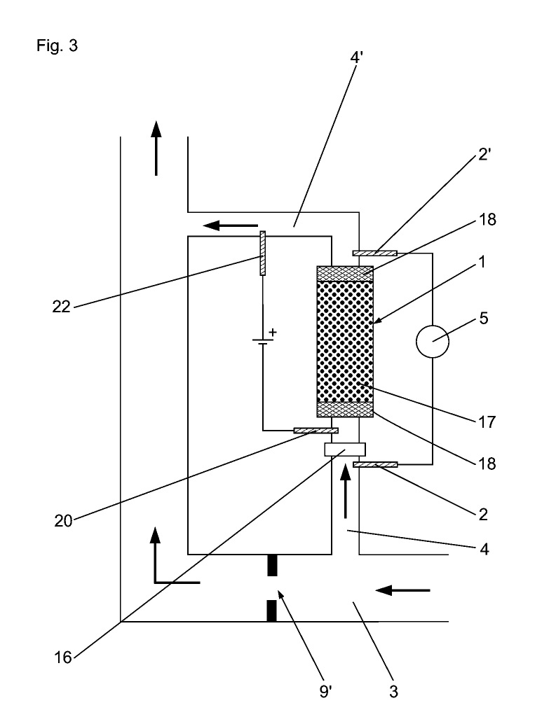

FIG. 3 is an alternative to the variant shown in FIG. 2, and

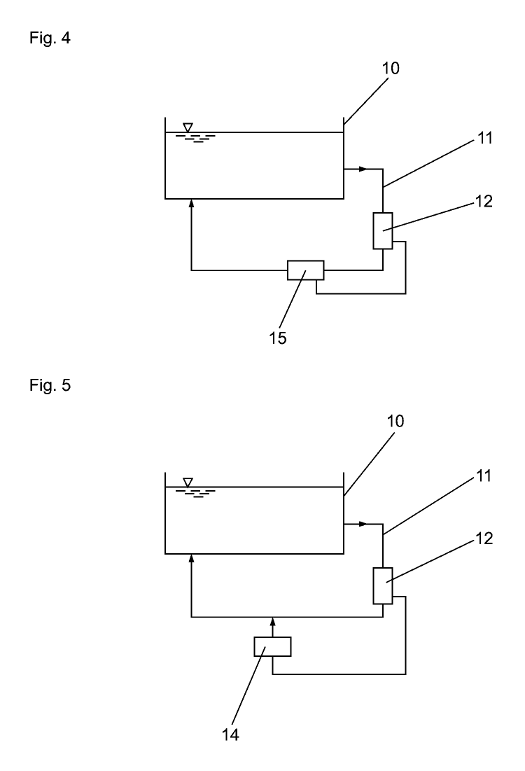

FIG. 4 and FIG. 5 are basic options for configuring or integrating a device according to the invention in a water circuit.

The device according to the invention is installed as a bypass in a water circuit or water pipeline system in which the concentration(s) of the oxidizing agent or agents contained in the water is/are to be determined, and connected to a flow tube 3 or similar, through which the water to be measured flows. As is shown in FIGS. 1 to 3, the device according to the invention comprises a pipe 4 branching off from flow tube 3 and a pipe 4′ that discharges to into pipe 3 at a distance therefrom. Pipes 4, 4′ may particularly have constant, matching cross-sections, which are significantly smaller than the cross-section of tube 3. The most significant factor is the flowrate of the water in the bypass flow. The device according to the invention is designed for a flowrate between 0.1 l/hour to 20 l/hour depending on the application, when used for treatment of pool water, it is designed for a flowrate between 0.5 l/hour and 2 l/hour. An elimination unit 1 is installed between the branching and the discharging pipes 4, 4′, and the partial stream that is split off from the main stream flowing in flow tube 3 is diverted through this elimination unit. The directions of flow of the main stream and the partial stream are indicated in FIGS. 1 to 3 by arrows. The device according to the invention includes measuring electrodes 2, 2′ arranged before elimination unit 1 and after elimination unit 1 viewed in the direction of flow, which electrodes are immersed in the water and connected to measuring electronics 5. In this context, measuring electrode 2 may be immersed at any point in the partial stream in pipe 4 or in the main stream in flow tube 3. Measuring electrode 2′ is located at any point after elimination unit 1 in discharging pipe 4′. The arrangement of the device as a bypass creates the closed circuit necessary for the measuring operation.

In the design variant shown in FIG. 1, a constant flowrate through elimination unit 1 is assured by a pump 6 positioned in branching pipe 4 and having a displacement capacity that is synchronized with the desired flowrate, in order to ensure complete or a defined (as a constant percentage) elimination of the oxidizing agent(s) after the oxidizing agents have passed through elimination unit 1 depending on the capacity of elimination unit, which will be described in the following.

A constant flowrate or constant partial flow may be assured alternatively or additionally by other mechanical (hydraulic) or electrical devices. In FIG. 2, a constant flowrate or constant flow through elimination unit 1 is produced by means of hydraulic devices/components. A bypass line 7 is provided parallel to elimination unit 1, which bypass line branches off before elimination unit 1 and discharges into pipe 4′ after the elimination unit. Die Bypass line 7 particularly has a constant cross-section, which is smaller than that of pipes 4, 4′. A valve 8 is located bypass line 7 immediately after the branching point from pipe 4 and this valve opens when the pressure in the partial flow flowing through branching pipe 4 exceeds a certain value. A device that reduces the cross-section of pipe 4, for example a choke 9 or a diaphragm, may be installed in pipe 4 after the branching of bypass line 7 as another means for ensuring a constant flow through elimination unit 1. In addition, a choke 9′ or diaphragm is installed immediately after branching pipe 4 in flow tube 3 through which the main stream flows, which serves to increase the pressure and create the partial flow in branching pipe 4. Known chokes or adjustable butterfly valves are suitable for such purpose. Perforated discs, breaker plates or the like that reduce the cross-sections in flow tube 3 and/or pipe 4 correspondingly may be used in addition or alternatively to butterfly valves or valves. In the alternative embodiment shown in FIG. 3, a choke 9′ in flow tube 3 also serves to increase pressure and causes a partial flow to branch off into pipe 4. A flow controller 16 of known construction installed before elimination unit 1 ensures that the flowrate remains constant.

The two measuring electrodes 2, 2′ determine the potential difference between the water before it enters elimination unit 1 and the water after it has passed through elimination unit 1. The measured values are analyzed in measuring electronics 5. Elimination unit 1 eliminates the oxidizing agent(s) contained in the water entirely or partially and/or selectively. The potential difference determined is proportional to the oxidation equivalents. For example, if setting a higher flowrate of water through elimination unit 1 causes only a certain percentage of oxidizing agents to be eliminated or broken down, the proportionality of the signal to the overall quantity of oxidants is unchanged.

In any case, the device must be calibrated once. If the oxidizing agent or agents is/are not to be broken down entirely a measurement must also be carried out with a known method to determine the degree of breakdown in terms of percentage. As will be explained in the following, this is significant for controlling a metering device for oxidizing agents if such is used.

Alternatively, the device may be calibrated internally by extrapolating the breakdown percentage for different flowrate velocities. For this, the configuration is charged with an aqueous solution containing oxidizing agents at different flowrate velocities. From these, a “flowrate against potential” calibration curve is plotted. From this curve, the theoretical flowrate velocity is determined for 100% elimination. A potential corresponds to this value, so that it is possible to calculate the activity of the oxidizing agents under investigation directly using the Nernst equation:

$$Δ E = \frac{RT}{{z}_{e} F} ln \frac{{a}_{g}}{{a}_{k}}$$

a_{g} stands for the activity of the higher concentration before elimination unit 1,

aₖ stands for the activity of the lower concentration after elimination unit 1.

The activity of the oxidizing agents in the concentration may be equated or at least correlated proportionally with good approximation in known systems.

In the range from 22° C. to 26° C., RT/F may be equated to 0.059. Z is assumed to be 1 if the objective is to determine the oxidation equivalent.

The oxidizing agent(s) in water may be eliminated or broken down as it/they flow(s) through elimination unit 1 by various means. In the simplest case, elimination unit 1 comprises a pipe, a tube or similar that is filled with an activated charcoal bed 17. For example, activated charcoal in the form of pellets of a size between 0.5 mm and 6 mm is suitable. The pipe, tube or similar is closed off on both sides by a water-permeable cap 18 and for example has a length from a few centimeters to several meters (in the tube configuration) and a diameter from 10 mm up to 5 cm. Activated charcoal is able to break down oxidizing agents by virtue of its highly porous structure and catalytic properties. The catalytic effect may be reinforced by introducing additional catalysts such as palladium, platinum, rhodium, ruthenium, cobalt, iron, copper chromite and zinc chromite into elimination unit 1, for example as a coating or casing of activated charcoal particles. The reduction performance may also be improved by creating a cathodic potential in the activated charcoal bed, for example by inserting an electrode 19 (FIG. 1) such as a carbon rod in the bed 17. Alternatively or additionally thereto, hydrogen may be produced at an electrode 20 (FIG. 3) (cathode) before elimination unit 1, the hydrogen being transported with the water into elimination unit 1, where it reacts with the oxidizing agent(s) on the surface of the activated charcoal. Anodes 21, 22 that are paired with electrodes 19, 20 are located for example downstream from measuring electrode 2′ in pipe 4′, so that the oxidizing agents formed on these anodes do not affect the measured value.

In other embodiments, elimination unit 1 contains at least one catalyst, such as palladium, nickel, platinum, rhodium, ruthenium, cobalt, iron, copper chromite and zinc chromite. The catalysts are introduced into unit 1 in the form of correspondingly coated carrier material, for example. One or more oxidizing agents present in the water is/are decomposed in elimination unit 1 selectively according to the catalyst material. In this context, a device according to the invention may also include several elimination units 1, each of which contains different catalysts, which are arranged in series and through which the partial stream flows one after the other. Alternative or additional measures for catalysts or activated charcoal are various water treatment steps as is passes through elimination unit 1, particularly a defined effect of heat, treatment with UV radiation, or ultrasound.

The oxidizing agent(s) in the water may also be broken down by feeding hydrogen to them directly. For example, the hydrogen may be introduced into elimination unit 1, which may also contain activated charcoal and/or one or more of the cited catalysts from a container 23 (FIG. 3) via a metering device.

Selective catalysts with platinum or palladium base that have been poisoned with a catalyst poison such as metals or metal ions, for example Ca, Mg, Pb, may also be used in elimination unit 1, so that selectively determined oxidizing agents may be broken down.

As was indicated in the preceding, at least one cathode may be attached inside elimination unit 1, and defined reduction potentials applied so as to selectively break down oxidizing agents that are reduced by the application of the respective potential.

When selecting the electrode material for measuring electrodes 2, 2′ to measure the to potential difference, it must be ensured that the liquid to be measured does not lead to any reactions that would change the inherent potential of measuring electrodes 2, 2′. The two measuring electrodes 2, 2′ are preferably of identical design, and electrodes of the first kind are used as measuring electrodes 2, 2′, that is to say electrodes whose potential depends directly on the concentration of ions in the liquid to be measured. Suitable electrode materials are particularly precious metals, such as platinum, iridium, gold or silver. Dimensionally stable electrodes such as titanium-mixed oxide electrodes or electrodes of titanium-iridium oxide are also suitable candidates, as are electrode materials such as carbon, carbon fiber, graphite, glassy carbon, and boron-doped diamond electrodes or doped silicon electrodes.

A reducing agent, H₂ for example, may be produced on other electrodes, for example the electrode 20 cited in the preceding, by electrolyzing the liquid to be measured, which reducing agent is capable of reducing an oxidizing agent selectively, partially or completely either alone or in combination with the catalysts in elimination unit 1. Other, similarly arranged electrodes that are not represented may also generate reducing agents, for example reactive metal ions such as iron (I), iron (II), zinc (I), copper (I), aluminum (I), aluminum (II), magnesium (I), these metal ions being capable of reducing oxidizing agents selectively, partially or completely either alone or in combination with the catalyst(s) inside elimination unit 1. As was mentioned earlier, alternatively a reducing agent such as H₂ may be introduced into elimination unit 1 in metered quantities, and this too may reduce the oxidizing agent(s) selectively, partially or completely.

In order to reduce biofilm formation on measuring electrodes 2, 2′ or to remove any deposits that have accumulated on measuring electrodes 2, 2′, continuous measurement may be interrupted for a few minutes at regular intervals and a voltage of several volts may be applied to measuring electrodes 2, 2′, so that the gas-phase products of electrolysis of the liquid being measured, which surround electrodes 2, 2′ (hydrogen at the cathode, oxygen at the anode) dislodge the deposits from the electrode surfaces to keep the reactive surfaces in a condition for measuring the potential difference.

A signal in the millivolt range is measured via a high-impedance measuring input of an amplifier circuit, a field effect transistor or an operational amplifier is preferably connected to electrodes 2, 2′ via a correspondingly high-impedance input. These components are included in measuring electronics 5. The voltage at electrodes 2, 2′ is zero when no oxidizing agents are being broken down in elimination unit 1. If the concentration of oxidizing agent(s) is different after it passes through elimination unit 1, the measured potential changes proportionally to the change in concentration (higher concentration before elimination unit 1 produces a greater proportional difference), although the proportionality is not necessarily linear.

Devices according to the invention are preferably designed as replaceable units, and each one comprises at least the two measuring electrodes 2, 2′, an elimination unit 1 and the associated feed and drainage pipes 4, 4′. Measuring electronics 5 may be partly or completely integrated in the replaceable unit. A measurement signal, an encoded measurement signal (frequency-modulated, digitally or as a mA loop) or a control signal is transmitted from measuring electronics 5 to an external controller, to regulate or control the addition of controllably metered quantities of oxidizing agents or regulate or control the production of oxidizing agents.

FIG. 4 and FIG. 5 show basic configurations of a device 12 according to the invention, which is designed as a replaceable unit, in a closed water circuit 11, which is for example a water circuit for treating swimming pool water from a pool 10 or water from a jacuzzi. A device 12 according to the invention is installed as a replaceable unit in water circuit 11. Alternatively, the device may be connected directly to the pool 10. As was explained in the foregoing, the values recorded by the measuring electronics in device 12 are used to control a metering unit 14 (FIG. 5) for feeding metered quantities of oxidizing agent. As is shown in FIG. 4, the measurement values may also be used to regulate a device 15 for producing oxidizing agents by anodic oxidation.

The device according to the invention and the metered addition of oxidizing agents and/or production of oxidizing agents that this controls may also be used for hot tubs, bathtubs, or in treating process water or drinking water.

### KEY TO REFERENCE NUMBERS

1 Elimination unit
2, 2′ Measuring electrodes
3 Flow tube
4 Branch pipe
4′ Discharge pipe
5 Measuring electronics
6 Pump
7 Bypass line
8 Valve
9, 9′ Butterfly valve
10 Pool
11 Water circuit
12 Device
14 Metering unit
15 Device
16 Flow controller
17 Activated charcoal bed
18 Cap
19, 20 Electrode (cathode)
21, 22 Electrode (anode)
23 Container

1. A method for determining the concentration of oxidizing agent(s) in an aqueous solution flowing in a main stream,
characterized in that
a partial flow of the aqueous solution is diverted from the main flow to a bypass, wherein the difference between the potential of the aqueous solution before and after at least partial and/or selective breakdown of any oxidizing agents present is measured in the bypass.

2. The method as recited in claim 1, characterized in that the potential difference is measuring using two measuring electrodes, which are particularly electrodes of the first kind, preferably titanium-mixed oxide electrodes, graphite electrodes, carbon electrodes, or boron-doped diamond electrodes.

3. The method as recited in claim 1, characterized in that the aqueous solution flowing in the partial stream flows through an activated charcoal bed.

4. The method as recited in claim 1, characterized in that the aqueous solution flowing in the partial stream flows through at least one catalyst, which is preferably made from platinum, palladium or nickel.

5. The method as recited in claim 4, characterized in that the catalyst is a selective, platinum- or palladium-based catalyst that is poisoned with a catalyst poison such as metals or metal ions.

6. The method as recited in claim 3, characterized in that the activated charcoal bed is placed on a cathodic potential, wherein an oxidizing agent that is reducible with a given potential may be broken down selectively by the application of the respective potential.

7. The method as recited in claim 4, characterized in that the catalyst is placed on a cathodic potential, wherein an oxidizing agent that is reducible with a given potential may be broken down selectively by the application of the respective potential.

8. The method as recited in claim 1, characterized in that the oxidizing agent(s) is/are broken down at least partially and/or selectively by a reducing agent, such as H₂, which is produced at another electrode (cathode).

9. The method as recited in claim 1, characterized in that the oxidizing agent(s) is/are broken down at least partially and/or selectively by a reducing agent, which is produced at another electrode by electrochemical dissolution.

10. The method as recited in claim 1, characterized in that the oxidizing agent(s) is/are broken down at least partially and/or selectively by a reducing agent, such as H₂, which is added continuously in metered quantities.

11. The method as recited in claim 1, characterized in that the oxidizing agent(s) is/are broken down at least partially and/or selectively by the effect of UV irradiation, heat or ultrasound.

12. A device for determining the concentration of oxidizing agent(s) in an aqueous solution flowing in a main stream,
characterized in that
it comprises a bypass for diverting and returning a partial flow of the aqueous solution,
at least one elimination unit located in the bypass of the partial stream of aqueous solution through which the aqueous solution flows for at least partial and/or selective breakdown of the oxidizing agent(s),
and two measuring electrodes for determining the difference between the potentials of the aqueous solution in the partial stream before and after it passes through the elimination unit (1).

13. The device as recited in claim 12, characterized in that it is equipped with measuring electronics.

14. The device as recited in claim 12, characterized in that the elimination unit is a pipe, a tube or the like which contains an activated charcoal bed and at least one catalyst.

15. The device as recited in claim 13, characterized in that the additional catalyst is a platinum, palladium or nickel catalyst or a selective, platinum- or palladium based catalyst that is poisoned with a catalyst poison.

16. The device as recited in claim 12, characterized in that it has an additional electrode for applying a cathodic potential to the activated charcoal bed.

17. The device as recited in claim 12, characterized in that it has an additional electrode (cathode) positioned before the elimination unit, which is provided to generate hydrogen or which releases a reducing agent by electrochemical dissolution.

18. The device as recited in claim 17, characterized in that the paired anode is positioned downstream of the second measuring electrode.

19. The device as recited in claim 12, characterized in that it contains a pump for introducing a partial steam.

20. The device as recited in claim 12, characterized in that it contains hydraulic components such as valves, chokes, diaphragms or the like for introducing and maintaining a constant partial stream.

21. The device as recited in claim 12, characterized in that a flow controller is placed before the elimination unit.

22. The device as recited in claim 13, characterized in that the measuring electronics provides measuring signals that are used to control an oxidizing agent metering device or a device for generating oxidizing agents in situ.

23. The device as recited in claim 12, characterized in that at least the measuring electrodes and the elimination unit are combined in a replaceable unit.

24. The device as recited in claim 22, characterized in that at least parts of the measuring electronics are integrated in the replaceable unit.
